(19) United States
(12) Patent Application Publication
(10) Pub. No.: US 2024/0085541 A1
(43) Pub. Date: Mar. 14, 2024

(54) FRAME SYNCHRONIZATION METHOD AND APPARATUS FOR LIDAR SYSTEM, AND COMPUTER-READABLE STORAGE MEDIUM

(71) Applicant: INNOVUSION (WUHAN) CO., LTD., Wuhan (CN)

(72) Inventor: Anxiao Ye, Wuhan (CN)

(73) Assignee: INNOVUSION (WUHAN) CO., LTD., Wuhan (CN)

(21) Appl. No.: 18/239,028

(22) Filed: Aug. 28, 2023

(30) Foreign Application Priority Data
Sep. 13, 2022 (CN) 202211106736.8

(51) Int. Cl. G01S 7/497; G01S 7/481

(52) U.S. Cl. CPC G01S 7/497; G01S 7/4811

(57) ABSTRACT

The present disclosure provides a frame synchronization method and apparatus for a LiDAR system, and a computer-readable storage medium. The method includes: determining whether to control a rotation speed of a rotating mirror to change by an adjustment value; determining a rotation speed compensation value for phase synchronization adjustment of the rotating mirror based on a phase difference, so that the phase difference between the phase of the rotating mirror when moving in the same period as the frame synchronization signal and the phase of the frame synchronization signal is less than or equal to a preset value; and controlling the rotation speed of the rotating mirror to be adjusted to a rotation speed used. Good synchronization between the rotating mirror in the LiDAR system and the frame synchronization signal is implemented.

### CROSS REFERENCE TO RELATED APPLICATIONS

This application claims priority to Chinese Patent Application No. 202211106736.8 filed on Sep. 13, 2022. The entire contents of these applications are hereby incorporated herein by reference.

### TECHNICAL FIELD

The present disclosure relates to the field of LiDAR system, and more specifically, to a frame synchronization method and apparatus for a LiDAR system, a computer device, an electronic device, a computer-readable storage medium, and a carrier system.

### BACKGROUND ART

In automated driving and intelligent transportation technologies, a laser radar is becoming an indispensable and important technical component. The automated driving is taken as an example, and the automated driving depends on good on-site perception and detection functions for virtual-real interaction. Currently, automated driving vehicle integration solutions are mostly based on multi-sensor fusion detection and performing complementary or fusion processing on multi-sensor data collected at a same time at an algorithm level.

However, in actual application, movable optical redirection elements in the laser radar, especially a rotating mirror, are not completely synchronized with a frame synchronization signal (such as an external frame synchronization signal), and there may be a drift between the two.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

An objective of the present disclosure is to provide a solution, which is capable of implementing good synchronization between a rotating mirror in a light detection and ranging (LiDAR) system and a frame synchronization signal.

According to a first aspect of an embodiment of the present disclosure, a frame synchronization method for a LiDAR system is provided, including: determining whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

According to a second aspect of an embodiment of the present disclosure, a frame synchronization apparatus for a LiDAR system is provided, including: a first unit configured to determine whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; a second unit configured to: after the period of the rotating mirror generating the point cloud with the predetermined number of frames is consistent with the period of the frame synchronization signal, determine a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and a third unit configured to: after the phase difference between the phase of the rotating mirror when moving in the same period as the frame synchronization signal and the phase of the frame synchronization signal is less than or equal to the preset value, control the rotation speed of the rotating mirror to be adjusted to a rotation speed used when the period of the rotating mirror generating the point cloud with the predetermined number of frames is consistent with the period of the frame synchronization signal.

According to a third aspect of an embodiment of the present disclosure, a computer device is provided, including: at least one processor; and at least one memory having a computer program stored thereon, where when executed by the at least one processor, the computer program causes the at least one processor to perform the foregoing frame synchronization method for the LiDAR system.

According to a fourth aspect of an embodiment of the present disclosure, an electronic device is provided, including a LiDAR system and the foregoing frame synchronization apparatus for the LiDAR system or the foregoing computer device.

According to a fifth aspect of an embodiment of the present disclosure, a computer-readable storage medium is provided, having a computer program stored thereon, where when executed by a processor, the computer program causes the processor to perform the foregoing frame synchronization method for the LiDAR system.

According to a sixth aspect of an embodiment of the present disclosure, a carrier system is provided, including: at least one LiDAR system as a first sensor; at least one second sensor; a frame synchronization signal generator configured to generate a frame synchronization signal that causes the at least one LiDAR system and the at least one second sensor to be synchronized; and the foregoing frame synchronization apparatus for the LiDAR system or the foregoing computer device.

According to one or more embodiments of the present disclosure, the frame synchronization method for the LiDAR system, the frame synchronization apparatus, the computer device, the electronic device, the computer-readable storage medium, and the carrier system are proposed. By using the frame synchronization method, the frame synchronization apparatus, the computer device, the electronic device, the computer-readable storage medium, or the carrier system, the rotation speed of the rotating mirror in the LiDAR system is dynamically adjusted, thus implementing good synchronization between the movement of the rotating mirror in the LiDAR system and the frame synchronization signal.

### BRIEF DESCRIPTION OF THE DRAWINGS

The drawings exemplarily show embodiments and form a part of the specification, and are used to illustrate exemplary implementations of the embodiments together with a written description of the specification. The embodiments shown are merely for illustrative purposes and do not limit the scope of the claims. Throughout the accompanying drawings, the same reference numerals denote same elements or similar but not necessarily same elements.

FIG. 1 is a schematic flowchart of a frame synchronization method for a LiDAR system according to an embodiment of the present disclosure;

FIG. 2 is a schematic flowchart of determining whether to control a rotation speed of a rotating mirror to change, dynamically based on a period difference in a frame synchronization method for a LiDAR system according to an embodiment of the present disclosure;

FIG. 3 is a schematic flowchart of determining a rotation speed compensation value for phase synchronization adjustment of a rotating mirror based on a phase difference in a frame synchronization method for a LiDAR system according to an embodiment of the present disclosure;

FIG. 4 is a schematic flowchart of determining a rotation speed compensation value for phase synchronization adjustment of a rotating mirror based on a phase difference in a frame synchronization method for a LiDAR system according to some other embodiments of the present disclosure;

FIG. 5 is a schematic flowchart of a frame synchronization method for a LiDAR system according to some other embodiments of the present disclosure;

FIG. 6 is a schematic block diagram of a frame synchronization apparatus for a LiDAR system according to an embodiment of the present disclosure; and

FIG. 7 is a schematic diagram of a carrier including a centralized laser delivery system and a LiDAR system according to an embodiment of the present disclosure.

### DETAILED DESCRIPTION OF EMBODIMENTS

The present disclosure will be further described in detail below with reference to the drawings and embodiments. It can be understood that specific embodiments described herein are used merely to explain a related invention, rather than limit the invention. It should be additionally noted that, for ease of description, only parts related to the related invention are shown in the drawings.

It should be noted that the embodiments in the present disclosure and features in the embodiments can be combined with each other without conflict. If the number of elements is not specifically defined, there may be one or more elements, unless otherwise expressly indicated in the context. In addition, numbers of steps or functional modules used in the present disclosure are used merely to identify the steps or functional modules, rather than limit either a sequence of performing the steps or a connection relationship between the functional modules.

In the present disclosure, unless otherwise stated, the terms “first”, “second”, etc., used to describe various elements are not intended to limit the positional, temporal or importance relationship of these elements, but rather only to distinguish one element from the other. In some examples, the first element and the second element may refer to the same instance of the element, and in some cases, based on contextual descriptions, the first element and the second element may also refer to different instances.

The terms used in the description of the various examples in the present disclosure are for the purpose of describing particular examples only and are not intended to be limiting. If the number of elements is not specifically defined, there may be one or more elements, unless otherwise expressly indicated in the context. Moreover, the term “and/or” used in the present disclosure encompasses any of and all possible combinations of listed items.

A “LiDAR” refers to a system that uses light to detect a target position and obtain feature quantities such as a target distance, a target speed, and a target attitude. Generally, the LiDAR system may include a light source, a signal deflection system, and an optical detector. The light source is configured to generate an optical pulse. The signal deflection system is used to direct an optical pulse emitted by the LiDAR system to a specific direction, and may direct the emitted optical pulse along different paths, so that the LiDAR system can scan the surrounding environment. The optical pulse emitted by the LiDAR system is reflected or scattered after reaching surrounding objects, some of the reflected or scattered light is returned to the LiDAR system as a return signal, and the signal deflection system may also be configured to redirect a returned optical signal to the optical detector. The optical detector is configured to detect the returned optical signal. For example, the LiDAR system may determine a distance to an object along a path of the emitted optical pulse by using the time and speed of light used to detect the returned optical signal after emitting the optical pulse. It is easy for those skilled in the art to understand that the LiDAR system may also use other technologies to measure the surrounding environment.

The “signal deflection system” is a system of changing the direction of an optical signal. The signal deflection system may include one or more optical redirection elements (for example, a mirror or lens), and the one or more optical redirection elements, for example, by rotation, vibration, or guidance, deflect the optical pulse along an emission path to scan the external surrounding environment. The signal deflection system may further include one or more optical redirection elements (for example, a mirror or lens), and the one or more optical redirection elements, for example, by rotation, vibration, or guidance, deflect the returned optical signal along a receiving path to direct the returned optical signal to the optical detector. The optical redirection element of directing the optical signal along the emission and receiving paths may be a same component (for example, a common component), a separate component (for example, a dedicated component), and/or a combination of the common and separate components. For example, these optical redirection elements may include a galvanometer mirror, a rotating mirror (such as a rotary polygon mirror), or a fixed mirror, to deflect the emitted pulse signal or the received return signal to different directions.

The “rotating mirror” refers to an optical element that deflects the optical pulse or the optical signal through rotational movement of the mirror. In some examples, the rotating mirror is configured to be capable of rotating 360 degrees clockwise or counterclockwise, which is used to, for example, scan one or more signals in a horizontal direction of the LiDAR system.

The “galvanometer mirror” refers to an optical element that deflects the optical pulse or the optical signal through vibrational movement of the mirror. In some examples, the galvanometer mirror is configured to be capable of moving downward or upward by a predetermined angle, which is used to, for example, scan one or more signals in a vertical direction of the LiDAR system.

In a LiDAR system including a plurality of movable optical redirection elements, the plurality of movable optical redirection elements are need to have good synchronization to obtain a screen of complete and accurate point cloud data. Thus, in some examples, a frame synchronization signal is provided for synchronizing the movement of the plurality of movable optical redirection elements, and may also be used for synchronizing the LiDAR system with external sensors and/or other external components in terms of time. The frame synchronization signal may be an external synchronization signal, such as a PTP signal or a GPTP signal. However, in actual application, a clock of the movable optical redirection element in the LiDAR system is not exactly the same as a clock of the frame synchronization signal, and there may be a drift between the two. In addition, even if the period of movement and phase of the optical redirection element are calibrated to be consistent with those of the frame synchronization signal, a deviation may occur again during the operation of the LiDAR system.

According to embodiments of the present disclosure, a frame synchronization method for a LiDAR system is proposed, and by using the frame synchronization method, the optical redirection element of the LiDAR system may be well synchronized with the frame synchronization signal. The optical redirection element includes a rotating mirror and/or a galvanometer mirror.

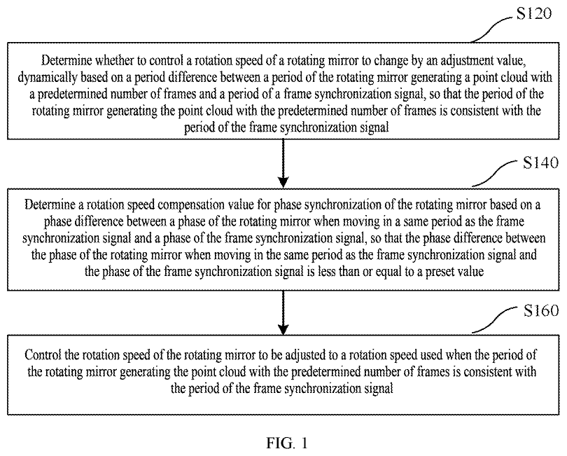

FIG. 1 is a schematic flowchart of a frame synchronization method 100 for a LiDAR system according to some embodiments of the present disclosure. As shown in FIG. 1, the frame synchronization method 100 for the LiDAR system may include: step S120: determining whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; step S140: after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and step S160: after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

Through the above method, good synchronization between the rotating mirror and the frame synchronization signal may be achieved. In the method according to this embodiment of the present disclosure, if it is determined that the period of the rotating mirror generating the point cloud with the predetermined number of frames is different from the period of the frame synchronization signal, the rotation speed of the rotating mirror is dynamically adjusted until the period of the rotating mirror generating the point cloud with the predetermined number of frames is consistent with that of the frame synchronization signal; after the period of the rotating mirror is adjusted, the phase of the rotating mirror when moving in the same period as the frame synchronization signal is adjusted, thus making the phase of the rotating mirror approximate to the phase of the frame synchronization signal; and after the phase of the rotating mirror when moving in the same period as the frame synchronization signal is adjusted, the rotation speed of the rotating mirror is adjusted to the rotation speed used when the period of the rotating mirror generating the point cloud with the predetermined number of frames is consistent with the period of the frame synchronization signal, that is, a final rotation speed in step S120. Therefore, good synchronization between the period of the rotating mirror generating the point cloud with the predetermined number of frames and the period of the frame synchronization signal and between the phase of the rotating mirror and the phase of the frame synchronization signal may be achieved.

The term “consistent” is not intended to define absolute consistency, and an adjustment error of the rotating mirror and an error generated by a motor may be considered in the present disclosure. That is, within an allowable error range, even if the period of the rotating mirror generating the point cloud with the predetermined number of frames is not absolutely consistent, but is basically consistent or tends to be consistent with the period of the frame synchronization signal, it may be considered that the period of the rotating mirror generating the point cloud with the predetermined number of frames is consistent with the period of the frame synchronization signal in the present disclosure.

In some embodiments, in step S120, a difference between a current period of the rotating mirror in the LiDAR system that generates the point cloud with the predetermined number of frames and the period of the frame synchronization signal is dynamically determined, for example, at a certain time interval (for example, at an interval of 150 milliseconds), and accordingly, it is determined whether to adjust the rotation speed of the rotating mirror. Usually, the LiDAR system performs scans repeatedly to obtain multi-frame point cloud data of the surrounding environment. One frame of point cloud, also known as one screen of point cloud, refers to one frame of complete point cloud data in an area to be measured that can be obtained by the LiDAR system within the field of view. The period of the rotating mirror generating one frame of point cloud is the time when the LiDAR system can obtain one frame of complete point cloud data in the area to be measured through the rotational movement of the rotating mirror. Exemplarily, if the rotating mirror rotates for at least one revolution (for example, 8 revolutions to 15 revolutions), the LiDAR system can obtain one frame of point cloud data, that is, the period of the rotating mirror generating one frame of point cloud is the time when the rotating mirror rotates for at least one revolution (for example, 8 revolutions to 15 revolutions). The period of the frame synchronization signal may be an integer multiple of the period of the rotating mirror generating one frame of point cloud, which is equivalent to a period of the LiDAR system generating multi-frame point cloud due to rotational movement of the rotating mirror. According to the selected frame synchronization signal, a predetermined integer multiple relationship between its period and the period of the rotating mirror generating one frame of point cloud is obtained, and when the LiDAR system is started or operated, step S120 is performed to check whether the predetermined integer multiple relationship between them is met.

As a rotatable mechanical component, the rotating mirror of the LiDAR system has a large inertia, and if the adjustment value is too large, jitter occurs in the point cloud data obtained by the LiDAR system through scanning, thus affecting the quality of the collected data. According to the embodiment of the present disclosure, the rotation speed of the rotating mirror is dynamically adjusted, that is, the rotation speed of the rotating mirror is slightly increased or decreased several times, to dynamically and stably adjust the period of the rotating mirror generating the point cloud with the predetermined number of frames, so that the period of the rotating mirror generating the point cloud with the predetermined number of frames gradually approaches an expected period (that is, the period of the frame synchronization signal). In some embodiments, the adjustment value is a parameter related to the rotating mirror itself. For example, the adjustment value is selected based on at least one of the following factors: a rotating mirror speed, rotating mirror mass, a rotating mirror inertia, and the like. The selected adjustment value can not only make the rotating mirror to be quickly adjusted to an expected value, but also ensure that jitter does not occur in the point cloud data obtained by scanning.

In some embodiments, in step S120, a current rotation speed of the rotating mirror is obtained, and how to adjust the rotation speed of the rotating mirror is determined based on a current difference between the period of the rotating mirror generating the point cloud with the predetermined number of frames and the period of the frame synchronization signal until the period of the rotating mirror generating the point cloud with the predetermined number of frames is consistent with the period of the frame synchronization signal. Thus, based on the rotation speed sampled in real time of the rotating mirror, the difference between the period of the rotating mirror generating the point cloud with the predetermined number of frames and the expected period (that is, the period of the frame synchronization signal) is calculated, and the difference is used as an input that controls the system, to adjust the rotation speed of the rotating mirror, so that the rotation speed of the rotating mirror may be adjusted stably and accurately through such closed-loop control.

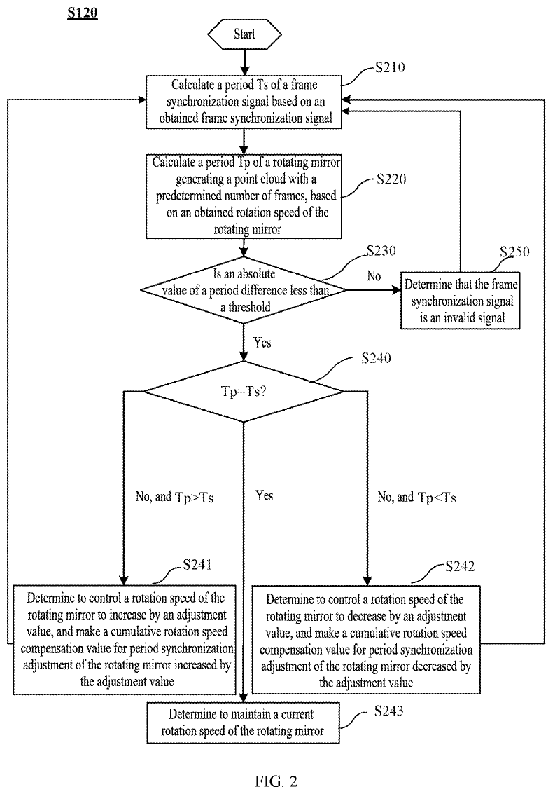

FIG. 2 is a schematic flowchart of determining whether to control a rotation speed of a rotating mirror to change, dynamically based on a period difference in a frame synchronization method 100 for a LiDAR system according to some embodiments of the present disclosure. In some embodiments, as shown in FIG. 2, in step S120, the determining whether to control a rotation speed of a rotating mirror in the LiDAR system to change by an adjustment value, dynamically based on a period difference between a period of the rotating mirror in the LiDAR system that generates a point cloud with a predetermined number of frames and a period of a frame synchronization signal includes: S210, calculating the period Ts of the frame synchronization signal based on an obtained frame synchronization signal; S220, calculating the period Tp of the rotating mirror generating the point cloud with the predetermined number of frames based on an obtained rotation speed of the rotating mirror; S230, calculating the period difference ΔT=Tp−Ts between the period of the rotating mirror generating the point cloud with the predetermined number of frames and the period of the frame synchronization signal, and determining whether an absolute value of the period difference ΔT is less than a period difference threshold ΔT_{Unit}; and S240, if the absolute value of the period difference is less than the period difference threshold and not equal to zero, that is, 0<|Tp−Ts|<ΔT_{Unit}, determining to control the rotation speed of the rotating mirror to change by the adjustment value, for example, to increase or decrease by the adjustment value.

It should be noted that for steps S210 and S220, the present disclosure does not limit the order in which they are performed and examples in FIG. 2 are only illustrative. The above steps S210 to S240 are repeated, for example, repeating the steps S210 to S240 at a certain time interval until the difference between the period of the rotating mirror generating the point cloud with the predetermined number of frames and the period of the frame synchronization signal is zero. That “the difference is zero” is not intended to define an absolute zero value, and an adjustment error of the movable optical redirection element and an error generated by a motor may be considered in the present disclosure. That is, within an allowable error range, even if the difference between the period of the rotating mirror generating the point cloud with the predetermined number of frames and the period of the frame synchronization signal is not absolutely zero, it may be considered that the period of the rotating mirror generating the point cloud with the predetermined number of frames is consistent with the period of the frame synchronization signal in the present disclosure.

Determining to control the rotation speed of the rotating mirror to change by the adjustment value, in response to the absolute value of the period difference being less than the period difference threshold and not equal to zero includes: S242, when the period of the rotating mirror generating the point cloud with the predetermined number of frames is less than the period of the frame synchronization signal, that is, Tp<Ts, determining to control the rotation speed of the rotating mirror to decrease by the adjustment value, and calculating a cumulative rotation speed compensation value for period synchronization adjustment of the rotating mirror according to the following equation:

ΔVpᵢ=ΔVpᵢ₋₁−ΔV1 (1);

S241, when the period of the rotating mirror generating the point cloud with the predetermined number of frames is greater than the period of the frame synchronization signal, that is, Tp>Ts, determining to control the rotation speed of the rotating mirror to increase by the adjustment value, and calculating a cumulative rotation speed compensation value for period synchronization adjustment of the rotating mirror according to the following equation:

ΔVpᵢ=ΔVpᵢ₋₁+ΔV1 (2);

in the above equations (1) and (2), where i is a natural number, ΔV1 is an adjustment value, ΔVpᵢ is a cumulative rotation speed compensation value from determination for a first time to control the rotation speed of the rotating mirror to change to determination for an i^{th} time to control the rotation speed of the rotating mirror to change, and ΔVpᵢ₋₁ is a cumulative rotation speed compensation value from the determination for the first time to control the rotation speed of the rotating mirror to change to determination for an (i−1)^{th} time to control the rotation speed of the rotating mirror to change.

Exemplarily, if it is determined that the period of the rotating mirror generating the point cloud with the predetermined number of frames is not equal to the period of the frame synchronization signal, step S120 is triggered. During the first adjustment, based on a current relationship between the period of the rotating mirror in the LiDAR system that generates the point cloud with the predetermined number of frames and the period of the frame synchronization signal, the rotation speed of the rotating mirror is increased or decreased by the adjustment value, and in this case, the cumulative rotation speed compensation value is ΔVp₁=+ΔV1 or ΔVp₁=−ΔV1. During the second adjustment, based on a current relationship between the period of the rotating mirror in the LiDAR system that generates the point cloud with the predetermined number of frames and the period of the frame synchronization signal, the rotation speed of the rotating mirror is increased or decreased by the adjustment value, and in this case, the cumulative rotation speed compensation value is ΔVp₂=ΔVp₁+ΔV1 or ΔVp₂=ΔVp₁−ΔV1. By analogy, during the i^{th} adjustment, the rotation speed of the rotating mirror is increased or decreased by the adjustment value, and in this case, the cumulative rotation speed compensation value is ΔVpᵢ=ΔVpᵢ₋₁+ΔV1 or ΔVpᵢ=ΔVpᵢ₋₁−ΔV1. The above steps S210 to S242 are repeated until the period of the rotating mirror generating the point cloud with the predetermined number of frames is consistent with the period of the frame synchronization signal.

In step S120, the determining whether to control a rotation speed of a rotating mirror in the LiDAR system to change by an adjustment value, dynamically based on a period difference between a period of the rotating mirror generating a point cloud with a predetermined number of frames and a period of a frame synchronization signal further includes: S243, when the period of the rotating mirror generating the point cloud with the predetermined number of frames is equal to the period of the frame synchronization signal, that is, the period difference is zero, maintaining a current rotation speed of the rotating mirror, and determining the cumulative rotation speed compensation value for period synchronization adjustment of the rotating mirror. If the period of the rotating mirror generating the point cloud with the predetermined number of frames is consistent with the period of the frame synchronization signal after the N^{th} adjustment, the cumulative rotation speed compensation value for period synchronization adjustment is ΔVp=ΔVp_{N}. The rotation speed of the rotating mirror is a sum of an initial rotation speed V0 before adjustment and the cumulative rotation speed compensation value ΔVp for period synchronization adjustment.

In some examples, in step S120, the determining whether to control a rotation speed of a rotating mirror in the LiDAR system to change by an adjustment value, dynamically based on a period difference between a period of the rotating mirror generating a point cloud with a predetermined number of frames and a period of a frame synchronization signal further includes: S250, if the absolute value of the period difference is greater than the period difference threshold, determining that the frame synchronization signal is an invalid signal. If it is determined that the frame synchronization signal is an invalid signal, the process goes back to step S210 to re-obtain the frame synchronization signal, and repeat the above steps S210 to S240 until the difference between the period of the rotating mirror generating the point cloud with the predetermined number of frames and the period of the frame synchronization signal is zero. In some examples, the selection of the period difference threshold is related to the ability of a system (for example, an upper computer such as an SoC) that generates the frame synchronization signal, and the system that generates the frame synchronization signal will not generate a frame synchronization signal with an error exceeding the period difference threshold.

It should be noted that in the present disclosure, the adjustment value ΔV1 may be a determined value, for example, it may be a preset value; and the adjustment value ΔV1 may also be a variable value, and for example, the adjustment value ΔV1 may be adjusted in real time according to a current difference between the period of the rotating mirror and the period of the frame synchronization signal.

In some embodiments, when the LiDAR system is turned on, it is determined whether to implement at least one of the above steps S120 to S160 or S210 to S250, so that the period of the rotating mirror in the LiDAR system that generates the point cloud with the predetermined number of frames is consistent with the period of the frame synchronization signal and the phase of the rotating mirror when moving in the same period as the frame synchronization signal is approximately the same as the phase of the frame synchronization signal. Therefore, the frame synchronization method 100 for the LiDAR system further includes: obtaining a frame synchronization signal in response to a turn-on instruction of the LiDAR system, and calculating the period of the frame synchronization signal based on the obtained frame synchronization signal; and obtaining the rotation speed of the rotating mirror, and calculating the period of the rotating mirror generating the point cloud with the predetermined number of frames based on the obtained rotation speed of the rotating mirror.

During the use of the LiDAR system, the rotating mirror, the galvanometer mirror, and the frame synchronization signal will have a shift, and fluctuation of an intermediate processing signal will also cause a signal shift. In all states of the LiDAR system, the above frame synchronization method 100 for the LiDAR system is always operated. In some embodiments, during the operation of the LiDAR system, the frame synchronization signal and the rotation speed of the rotating mirror are periodically obtained, and it is determined whether the period of the rotating mirror generating the point cloud with the predetermined number of frames or its phase within the same period as the frame synchronization signal is consistent with the period or phase of the frame synchronization signal. If the period of the rotating mirror generating the point cloud with the predetermined number of frames is not consistent with the period of the frame synchronization signal, the above steps S120 to S160 are implemented. If the period of the rotating mirror generating the point cloud with the predetermined number of frames is consistent with the period of the frame synchronization signal, but its phase within the same period as the frame synchronization signal is not consistent with that of the frame synchronization signal, the above steps S140 to S160 are implemented. By using this method, it is ensured that during the operation of the LiDAR system, the period of the rotating mirror in the LiDAR system that generates the point cloud with the predetermined number of frames and its phase within the same period as the frame synchronization signal are consistent or tend to be consistent with the period and phase of the frame synchronization signal.

In some embodiments, the frame synchronization signal is sent periodically.

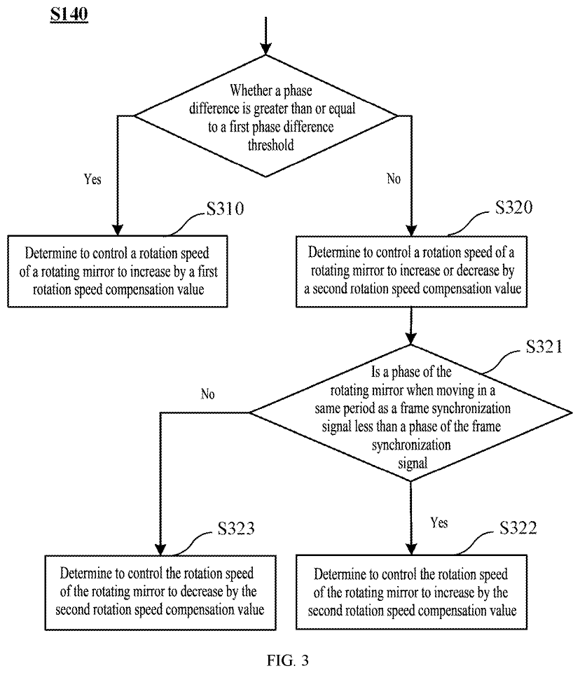

After the period of the rotating mirror generating the point cloud with the predetermined number of frames is consistent with the period of the frame synchronization signal, the phase of the rotating mirror when moving in the same period as the frame synchronization signal is adjusted to make the phase of the rotating mirror when moving in the same period as the frame synchronization signal approximate to the phase of the frame synchronization signal. FIG. 3 is a schematic flowchart of determining a rotation speed compensation value for phase synchronization adjustment of a rotating mirror based on a phase difference in a frame synchronization method 100 for a LiDAR system according to some embodiments of the present disclosure. In some embodiments, in step S140, the determining a rotation speed compensation value for phase synchronization adjustment of the rotating mirror based on a phase difference between a phase of the rotating mirror when moving in a same period as the frame synchronization signal and a phase of the frame synchronization signal includes: S310, determining to control the rotation speed of the rotating mirror to increase by a first rotation speed compensation value, in response to an absolute value of the phase difference between the phase of the rotating mirror when moving in the same period as the frame synchronization signal and the phase of the frame synchronization signal being greater than or equal to a first phase difference threshold; or S320, determining to control the rotation speed of the rotating mirror to increase or decrease by a second rotation speed compensation value, in response to an absolute value of the phase difference between the phase of the rotating mirror when moving in the same period as the frame synchronization signal and the phase of the frame synchronization signal being less than a first phase difference threshold, where the second rotation speed compensation value is less than the first rotation speed compensation value.

When the phase difference is relatively large, the original rotation speed of the rotating mirror is increased by a larger rotation speed compensation value, that is, the first rotation speed compensation value, to compensate the phase difference between the rotating mirror and the frame synchronization signal. This large forward addition of the phase may ensure a frame frequency, such that data collected by the rotating mirror in the period of the frame synchronization signal can form a complete point cloud. When the phase difference is relatively small, the original rotation speed of the rotating mirror may be slightly increased or decreased by a smaller rotation speed compensation value, that is, the second rotation speed compensation value, to keep the phases synchronized.

Step S140 further includes: when the phase of the rotating mirror when moving in the same period as the frame synchronization signal lags behind the phase of the frame synchronization signal, the rotation speed compensation value for phase synchronization adjustment of the rotating mirror being a positive value; and when the phase of the rotating mirror when moving in the same period as the frame synchronization signal leads the phase of the frame synchronization signal, the rotation speed compensation value for phase synchronization adjustment of the rotating mirror being a negative value. With reference to the embodiment shown in FIG. 3, step S140 further includes: S321, determining whether the phase of the rotating mirror when moving in the same period as the frame synchronization signal is less than the phase of the frame synchronization signal; and S322, in response to the fact that the phase of the rotating mirror when moving in the same period as the frame synchronization signal is less than the phase of the frame synchronization signal (that is, the phase of the rotating mirror moving in the same period as the frame synchronization signal lags behind the phase of the frame synchronization signal), determining to control the rotation speed of the rotating mirror to increase by the second rotation speed compensation value; or S323, in response to the fact that the phase of the rotating mirror when moving in the same period as the frame synchronization signal is greater than the phase of the frame synchronization signal (that is, the phase of the rotating mirror moving in the same period as the frame synchronization signal leads the phase of the frame synchronization signal), determining to control the rotation speed of the rotating mirror to decrease by the second rotation speed compensation value.

In some embodiments, in step S140, the determining a rotation speed compensation value for phase synchronization adjustment of the rotating mirror based on a phase difference between a phase of the rotating mirror when moving in a same period as the frame synchronization signal and a phase of the frame synchronization signal may further include: adjusting the rotation speed of the rotating mirror by using a predetermined rotation speed compensation value. For example, the rotation speed of the rotating mirror may be increased or decreased by a preset value to make it gradually approximate to the phase of the frame synchronization signal.

In some embodiments, before step S310, it may be firstly determined whether the absolute value of the phase difference between the phase of the rotating mirror when moving in the same period as the frame synchronization signal and the phase of the frame synchronization signal is greater than a second phase difference threshold, and if the absolute value is less than the second phase difference threshold, it is determined that the rotation speed compensation value for phase synchronization adjustment of the rotating mirror is zero, and a current rotation speed of the rotating mirror is maintained. The second phase difference threshold is less than the first phase difference threshold, which represents an allowable phase error.

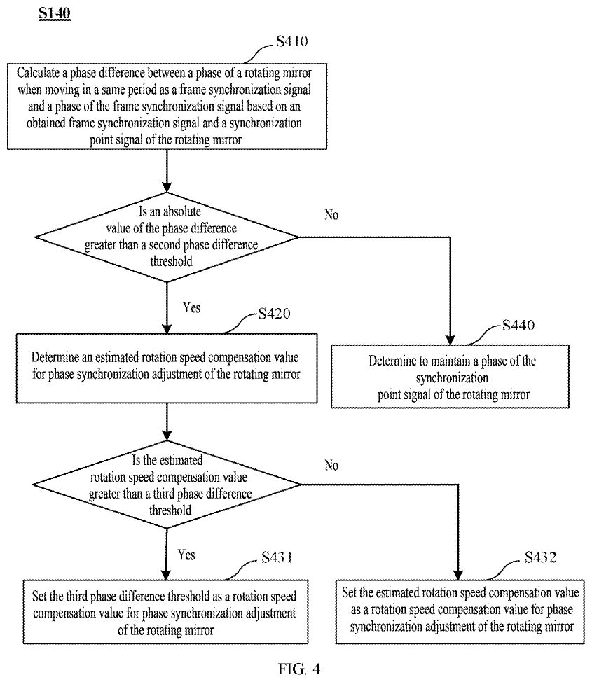

FIG. 4 is a schematic flowchart of determining a rotation speed compensation value for phase synchronization adjustment of a rotating mirror based on a phase difference in a frame synchronization method 100 for a LiDAR system according to some embodiments of the present disclosure. In some embodiments, in step S140, the determining a rotation speed compensation value for phase synchronization adjustment of the rotating mirror based on a phase difference between a phase of the rotating mirror when moving in a same period as the frame synchronization signal and a phase of the frame synchronization signal includes: S410, calculating the phase difference between the phase of the rotating mirror when moving in the same period as the frame synchronization signal and the phase of the frame synchronization signal based on an obtained frame synchronization signal and a synchronization point signal of the rotating mirror; and S420, in response to the calculated absolute value of the phase difference between the phase of the rotating mirror when moving in the same period as the frame synchronization signal and the phase of the frame synchronization signal being greater than a second phase difference threshold, determining an estimated rotation speed compensation value for phase synchronization adjustment of the rotating mirror according to the following equation:

ΔVφ_{estimated}=−Δφ×Kp,

where ΔVφ_{estimated} is the estimated rotation speed compensation value for phase synchronization adjustment of the rotating mirror, Δφ is the phase difference between the phase of the synchronization point signal of the rotating mirror and the phase of the frame synchronization signal, and Kp is an adjustment proportional gain. The synchronization point signal of the rotating mirror is a signal when the rotating mirror implements period synchronization with the frame synchronization signal, and when the rotating mirror is a multifaceted prism, the signal of the rotating mirror can be generated by, for example, the following methods: marking a setting face or setting side of the rotating mirror, so that a signal is emitted each time the rotating mirror reaches the setting face or setting side after rotating for one revolution.

Then, the determining the rotation speed compensation value for phase synchronization adjustment of the rotating mirror based on a relationship between an absolute value of the estimated rotation speed compensation value and a third phase difference threshold includes: S431, when the absolute value of the estimated rotation speed compensation value is greater than the third phase difference threshold, setting the third phase difference threshold as the rotation speed compensation value for phase synchronization adjustment of the rotating mirror; and S432, when the absolute value of the estimated rotation speed compensation value is less than or equal to the third phase difference threshold, setting the estimated rotation speed compensation value as the rotation speed compensation value for phase synchronization adjustment of the rotating mirror, that is, ΔVφ=ΔVφ_{estimated}=−Δφ×Kp.

On the basis of the cumulative rotation speed compensation value ΔVp for period synchronization adjustment, the rotation speed compensation value ΔVφ for phase synchronization adjustment is superimposed to obtain a final rotation speed compensation value ΔV of the rotating mirror.

In some embodiments, when the phase of the frame synchronization signal leads the phase of the rotating mirror when moving in the same period as the frame synchronization signal, the rotation speed compensation value for phase synchronization adjustment of the rotating mirror is a positive value; or when the phase of the frame synchronization signal lags behind the phase of the rotating mirror when moving in the same period as the frame synchronization signal, the rotation speed compensation value for phase synchronization adjustment of the rotating mirror is a negative value.

In some embodiments, in step S140, the determining a rotation speed compensation value for phase synchronization adjustment of the rotating mirror based on a phase difference between a phase of the rotating mirror when moving in a same period as the frame synchronization signal and a phase of the frame synchronization signal further includes: obtaining a frame synchronization signal, and calculating the phase of the frame synchronization signal based on the obtained frame synchronization signal; obtaining a synchronization point signal of the rotating mirror, and calculating the phase of the rotating mirror when moving in the same period as the frame synchronization signal based on the obtained synchronization point signal of the rotating mirror; and calculating the phase difference between the phase of the rotating mirror when moving in the same period as the frame synchronization signal and the phase of the frame synchronization signal. Exemplarily, in response to that the period of the rotating mirror generating the point cloud with the predetermined number of frames is equal to the period of the frame synchronization signal, the frame synchronization signal and the synchronization point signal of the rotating mirror are obtained.

In some embodiments, in step S140, the determining a rotation speed compensation value for phase synchronization adjustment of the rotating mirror based on a phase difference between a phase of the rotating mirror when moving in a same period as the frame synchronization signal and a phase of the frame synchronization signal further includes: S440, in response to the calculated absolute value of the phase difference between the phase of the rotating mirror when moving in the same period as the frame synchronization signal and the phase of the frame synchronization signal being less than the second phase difference threshold, determining to maintain the phase of the synchronization point signal of the rotating mirror, and setting the rotation speed compensation value for phase synchronization adjustment of the rotating mirror to zero, where the second phase difference threshold is equal to the preset value described in step S140.

In some embodiments, the first phase difference threshold, the second phase difference threshold, and the third phase difference threshold may be values that are set based on an actual operating phase of the rotating mirror in the LiDAR system and in consideration of an allowable range of other components associated with the rotation of the rotating mirror, where the first phase difference threshold and the third phase difference threshold are greater than the second phase difference threshold.

After the phase difference between the phase of the rotating mirror when moving in the same period as the frame synchronization signal and the phase of the frame synchronization signal is less than or equal to the preset value (such as the second phase difference threshold), the rotation speed of the rotating mirror is controlled to be adjusted to a rotation speed used when the period of the rotating mirror generating the point cloud with the predetermined number of frames is consistent with the period of the frame synchronization signal, that is, the final rotation speed of the rotating mirror in step S120, which is the sum of the initial rotation speed V0 before adjustment and the cumulative rotation speed compensation value for period synchronous adjustment.

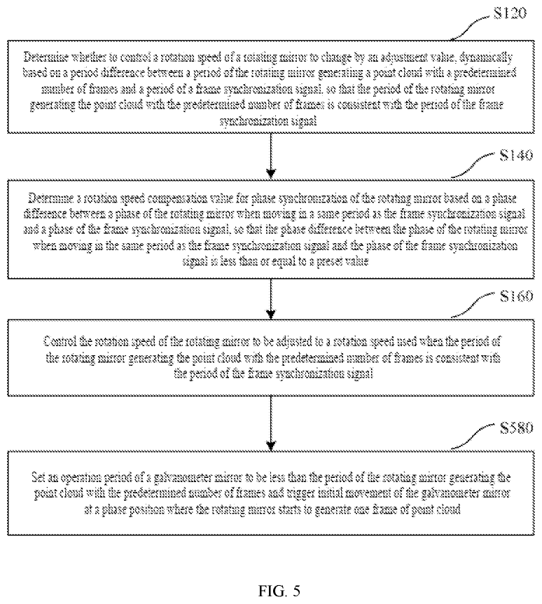

FIG. 5 is a schematic flowchart of a frame synchronization method for a LiDAR system according to some other embodiments of the present disclosure. As shown in FIG. 5, the frame synchronization method 100 for the LiDAR system further includes: S580, based on an adjusted period of the rotating mirror generating the point cloud with the predetermined number of frames and an adjusted phase of the rotating mirror when moving in the same period as the frame synchronization signal, setting an operation period of the galvanometer mirror to be less than the period of the rotating mirror generating one frame of point cloud, and triggering initial movement of the galvanometer mirror at a phase position where the rotating mirror starts to generate one frame of point cloud, so that a movement trajectory of the adjusted galvanometer mirror is synchronized with the adjusted period and phase of the rotating mirror. For example, if the period of the rotating mirror generating one frame of point cloud is the time when the rotating mirror rotates for at least one revolution (for example, 8 revolutions to 15 revolutions), the operation period of the galvanometer mirror is less than the time when the rotating mirror rotates for at least one revolution (for example, 8 revolutions to 15 revolutions). When the rotating mirror is a multifaceted prism, the phase position where the rotating mirror starts to generate one frame of point cloud is, for example, the position reached each time the rotating mirror reaches the setting face or setting side after rotating for one revolution, or the position reached each time it reaches the setting face or setting side after rotating for the at least one revolution (for example, 8 revolutions to 15 revolutions).

When the movement trajectory of the galvanometer mirror swings up and down, the galvanometer mirror swings from a lower limit position to an upper limit position (or swings from the upper limit position to the lower limit position), and the time taken by the galvanometer mirror to swing from the lower limit position to the upper limit position (or swing from the upper limit position to the lower limit position), that is, the operation period of the galvanometer mirror, is set to be less than the period of the rotating mirror generating one frame of point cloud. Therefore, it is necessary to control the movement of the galvanometer mirror every time it is at a limit position, so that its movement trajectory can be consistent with the periodic movement of the rotating mirror. Specifically, each time the galvanometer mirror completes the movement from the upper limit position to the lower limit position or from the lower limit position to the upper limit position, the galvanometer mirror is controlled to wait at the limit position until the phase position where the rotating mirror starts to generate one frame of point cloud, and at his time, the initial movement of the galvanometer mirror is triggered, so that the galvanometer mirror starts to move from the lower limit position or the upper limit position. For example, until a signal representing the movement of the rotating mirror is received, such as an encoded signal generated by an optical rotary encoder of the rotating mirror, a new swing movement is started in phase with the signal.

Through the above method, good synchronization between movement of the galvanometer mirror and the rotating mirror may be implemented. With reference to the method for adjusting the period and phase of the rotating mirror, the frame synchronization method can be implemented to adjust the period and phase of the rotating mirror and galvanometer mirror in the LiDAR system, so that good synchronization may be kept among the rotating mirror movement, the galvanometer mirror movement, and the frame synchronization signal.

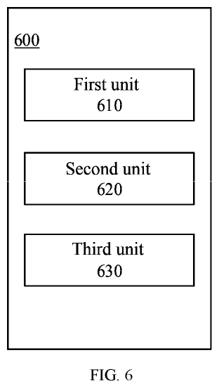

FIG. 6 is a block diagram of a frame synchronization apparatus 600 for a LiDAR system according to an embodiment of the present disclosure. As shown in FIG. 6, the frame synchronization apparatus for the LiDAR system may include a first unit 610, a second unit 620, and a third unit 630. The first unit 610 is configured to determine whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal. The second unit 620 is configured to: after the period of the rotating mirror generating the point cloud with the predetermined number of frames is consistent with the period of the frame synchronization signal, determine a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value. The third unit 630 is configured to: after the phase difference between the phase of the rotating mirror when moving in the same period as the frame synchronization signal and the phase of the frame synchronization signal is less than or equal to the preset value, control the rotation speed of the rotating mirror to be adjusted to a rotation speed used when the period of the rotating mirror generating the point cloud with the predetermined number of frames is consistent with the period of the frame synchronization signal.

In this embodiment, for specific implementations and technical effects of the frame synchronization apparatus 600 for the LiDAR system and its corresponding functional units 610 to 630, reference may be made to the relevant descriptions in the embodiments described in FIG. 1 to FIG. 5, and details are not repeated herein.

According to an embodiment of the present disclosure, the process described above with reference to the flowcharts may be implemented as a computer device, where the computer device may include a processing apparatus (for example, a central processing unit, a graphics processing unit, etc.), which may perform appropriate actions and processing according to a program stored in a read-only memory (ROM) or a program loaded from a storage apparatus to a random access memory (RAM).

According to an embodiment of the present disclosure, the process described above with reference to the flowcharts may be implemented as an electronic device, including a LiDAR system, and the foregoing frame synchronization apparatus for the LiDAR system or the foregoing computer device.

In particular, according to an embodiment of the present disclosure, the process described above with reference to the flowchart of FIG. 1 may be implemented as a computer software program. For example, an embodiment of the present disclosure provides a computer-readable storage medium that stores a computer program, and the computer program contains program code for performing the method 100 shown in FIG. 1. When the computer program is executed by the processing apparatus, the above-mentioned functions defined in the apparatus of the embodiment of the present disclosure are implemented.

It should be noted that a computer-readable medium described in the embodiments of the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the embodiments of the present disclosure, the computer-readable storage medium may be any tangible medium containing or storing a program which may be used by or in combination with an instruction execution system, apparatus, or device. In the embodiments of the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The foregoing computer-readable medium may be contained in the foregoing computer device; and alternatively, the computer-readable medium may exist independently, without being assembled into the computer device. The foregoing computer-readable medium carries one or more programs, and the one or more programs, when executed by the computing device, cause the computer device to perform the following: determining whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

According to another aspect of the present disclosure, a computer program product is provided, including a computer program, where the computer program, when executed by a processor, causes the processor to perform the frame synchronization method 100 according to any one of the embodiments.

Computer program code for performing operations of the embodiments of the present disclosure can be written in one or more programming languages or a combination thereof, where the programming languages include object-oriented programming languages, such as Java,

Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or wide area network (WAN), or may be connected to an external computer (for example, connected over the Internet using an Internet service provider).

According to another aspect of an embodiment of the present disclosure, a carrier system is provided, including: at least one LiDAR system as a first sensor; at least one second sensor; a frame synchronization signal generator configured to generate a frame synchronization signal that causes the at least one LiDAR system and the at least one second sensor to be synchronized; and the foregoing frame synchronization apparatus for the LiDAR system or the foregoing computer device.

The carrier system includes at least a LiDAR system as a sensor, and the LiDAR system synchronizes with other sensors and/or other components in the carrier through a frame synchronization signal. In the carrier system, for example, the LiDAR system may be used as a master control to send the frame synchronization signal, so that it can be synchronized with other sensors in the carrier system, such as a camera, a millimeter-wave radar, or another LiDAR system. In the carrier system, for example, a central control system may also send the frame synchronization signal, so that synchronization is implemented between the sensors (for example, the LiDAR system, the camera, or the millimeter-wave radar) or synchronization is implemented between the sensors and other components in the carrier.

The carrier includes, but is not limited to, a vehicle, an unmanned aerial vehicle, a ship, etc., and a scenario in which the carrier is used includes, but is not limited to, a system with a plurality of sensors, such as a roadside detection device, dock monitoring, intersection monitoring, and a factory.

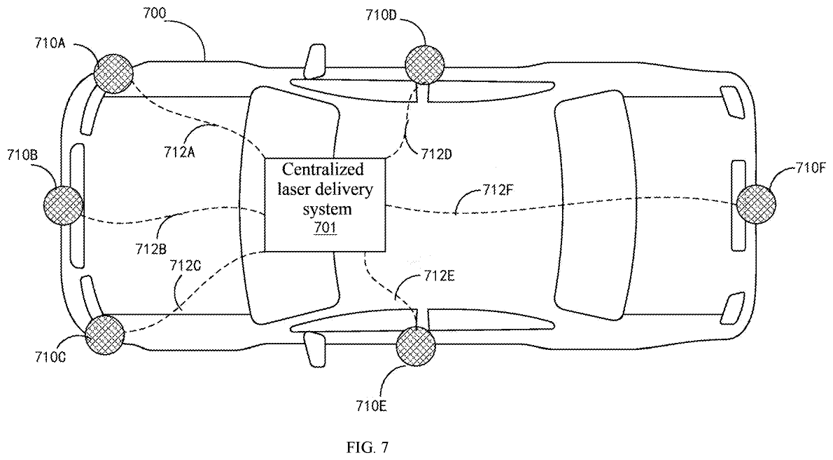

FIG. 7 illustrates an exemplary centralized laser delivery system 701 and a plurality of LiDAR systems arranged or included in a carrier 700. The carrier 700 may further include other sensors, such as a camera or a millimeter-wave radar (not shown in the figure). As shown in FIG. 7, the centralized laser delivery system 701 and the plurality of LiDAR systems 710A to 710F (collectively used as a LiDAR system scanning system 710) are arranged in the carrier 700. In some embodiments, the centralized laser delivery system 701 may be arranged in the carrier 700 at a predetermined position, or integrated with the carrier 700 at a predetermined position. The predetermined position may be, for example, at the center of the carrier, so that the plurality of LiDAR systems 710A to 710F are evenly distributed around the predetermined position of the centralized laser delivery system 701 to receive laser signals. In some examples, the centralized laser delivery system 701 may alternatively be arranged at a convenient position, such as in the neighborhood of a control circuit of the carrier 700. It should be appreciated that the centralized laser delivery system 701 may be arranged in any desired position of the carrier 700.

In some embodiments, depending on the state of the carrier 700, the centralized laser delivery system 701 may provide the laser signals to one or more of the plurality of LiDAR systems 710A to 710F. For example, the carrier 700 may move forward, thus it may be necessary to detect objects located in front of and on both sides of the carrier 700, but it may not be necessary to detect an object located behind the carrier 700. Therefore, the centralized laser delivery system 701 may provide the laser signals to the LiDAR systems 710A to 710E instead of the LiDAR system 710F, and the LiDAR system 710F is configured to detect the object located behind the carrier 700. As another example, the carrier 700 may move backward and it may be necessary to detect the object located behind the carrier 700. Therefore, the centralized laser delivery system 701 may provide the laser signals to the LiDAR system 710F.

In some embodiments, the centralized laser delivery system 701 may provide the laser signals by using one or more channels 712A to 712F (collectively used as a channel 712). The channel 712 may be, for example, a fiber channel. The channel 712 may be flexible, and thus may enable laser signals to be routed or delivered to any LiDAR system of the carrier 700. In some embodiments, the channel 712 may include a single-mode optical fiber and/or a multi-mode optical fiber. The channel 712 may transmit a laser signal with any desired wavelength. The laser signal is a signal that carries information by using a laser beam. The laser signal may include one or more of laser pulses, photons, or beams. The laser signal may be modulated or unmodulated. The laser signal may also have any wavelength and power.

For any one of the plurality of LiDAR systems 710A to 710F, good synchronization between the movement of its rotating mirror and/or galvanometer mirror and the frame synchronization signal may be implemented by the frame synchronization method for the LiDAR system according to any of the above embodiments.

The flowcharts and block diagrams in the accompanying drawings illustrate the possibly implemented architecture, functions, and operations of the method, apparatus, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The described units may also be arranged in the processor, which for example may be described as: a processor, including a first unit, a second unit, and a third unit. Names of these units do not constitute a limitation on the units themselves under certain circumstances.

Some exemplary solutions of the present disclosure are described below.

Solution 1. A frame synchronization method for a LiDAR system, where the LiDAR system includes a rotating mirror and the frame synchronization method includes: determining whether to control a rotation speed of the rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

Solution 2. The frame synchronization method according to solution 1, where the LiDAR system further includes a galvanometer mirror and the frame synchronization method further includes: based on an adjusted period of the rotating mirror generating the point cloud with the predetermined number of frames and an adjusted phase of the rotating mirror when moving in the same period as the frame synchronization signal, setting an operation period of the galvanometer mirror to be less than a period of the rotating mirror generating one frame of point cloud, and triggering initial movement of the galvanometer mirror at a phase position where the rotating mirror starts to generate one frame of point cloud.

Solution 3. The frame synchronization method according to solution 1 or 2, where the determining whether to control a rotation speed of the rotating mirror to change by an adjustment value, dynamically based on a period difference between a period of the rotating mirror generating a point cloud with a predetermined number of frames and a period of a frame synchronization signal includes: calculating the period of the frame synchronization signal based on an obtained frame synchronization signal; calculating the period of the rotating mirror generating the point cloud with the predetermined number of frames based on an obtained rotation speed of the rotating mirror; calculating the period difference between the period of the rotating mirror generating the point cloud with the predetermined number of frames and the period of the frame synchronization signal; and determining to control the rotation speed of the rotating mirror to change by the adjustment value, in response to an absolute value of the period difference being less than a period difference threshold and not equal to zero.

Solution 4. The frame synchronization method according to solution 3, where the determining to control the rotation speed of the rotating mirror to change by the adjustment value, in response to an absolute value of the period difference being less than a period difference threshold and not equal to zero includes: when the period of the rotating mirror generating the point cloud with the predetermined number of frames is less than the period of the frame synchronization signal, determining to control the rotation speed of the rotating mirror to decrease by the adjustment value, and calculating a cumulative rotation speed compensation value for period synchronization adjustment of the rotating mirror according to the following equation:

ΔVpᵢ=ΔVpᵢ₋₁−ΔV1; or

when the period of the rotating mirror generating the point cloud with the predetermined number of frames is greater than the period of the frame synchronization signal, determining to control the rotation speed of the rotating mirror to increase by the adjustment value, and calculating a cumulative rotation speed compensation value for period synchronization adjustment of the rotating mirror according to the following equation:

ΔVpᵢ=ΔVpᵢ₋₁+ΔV1,

where i is a natural number, ΔV1 is an adjustment value, ΔVpᵢ is a cumulative rotation speed compensation value from determination for a first time to control the rotation speed of the rotating mirror to change to determination for an i^{th} time to control the rotation speed of the rotating mirror to change, and ΔVpᵢ₋₁ is a cumulative rotation speed compensation value from the determination for the first time to control the rotation speed of the rotating mirror to change to determination for an (i−1)^{th} time to control the rotation speed of the rotating mirror to change.

Solution 5. The frame synchronization method according to any one of solutions 3 to 4, where the determining whether to control a rotation speed of the rotating mirror to change by an adjustment value, dynamically based on a period difference between a period of the rotating mirror generating a point cloud with a predetermined number of frames and a period of a frame synchronization signal further includes: determining that the frame synchronization signal is an invalid signal, in response to the absolute value of the period difference being greater than the period difference threshold.

Solution 6. The frame synchronization method according to any one of solutions 3 to 5, where the determining whether to control a rotation speed of the rotating mirror to change by an adjustment value, dynamically based on a period difference between a period of the rotating mirror generating a point cloud with a predetermined number of frames and a period of a frame synchronization signal further includes: determining to keep the rotation speed of the rotating mirror unchanged, in response to the period difference being equal to zero.

Solution 7. The frame synchronization method according to any one of solutions 1 to 6, where the determining a rotation speed compensation value for phase synchronization adjustment of the rotating mirror based on a phase difference between a phase of the rotating mirror when moving in a same period as the frame synchronization signal and a phase of the frame synchronization signal includes: adjusting the rotation speed of the rotating mirror by using a predetermined rotation speed compensation value.

Solution 8. The frame synchronization method according to any one of solutions 1 to 7, where the determining a rotation speed compensation value for phase synchronization adjustment of the rotating mirror based on a phase difference between a phase of the rotating mirror when moving in a same period as the frame synchronization signal and a phase of the frame synchronization signal includes: determining to control the rotation speed of the rotating mirror to increase by a first rotation speed compensation value, in response to an absolute value of the phase difference between the phase of the rotating mirror when moving in the same period as the frame synchronization signal and the phase of the frame synchronization signal being greater than or equal to a first phase difference threshold; or determining to control the rotation speed of the rotating mirror to increase or decrease by a second rotation speed compensation value, in response to an absolute value of the phase difference between the phase of the rotating mirror when moving in the same period as the frame synchronization signal and the phase of the frame synchronization signal being less than a first phase difference threshold, where the second rotation speed compensation value is less than the first rotation speed compensation value.

Solution 9. The frame synchronization method according to solution 8, where when the phase of the rotating mirror when moving in the same period as the frame synchronization signal lags behind the phase of the frame synchronization signal, determining to control the rotation speed of the rotating mirror to increase by the second rotation speed compensation value; and when the phase of the rotating mirror when moving in the same period as the frame synchronization signal leads the phase of the frame synchronization signal, determining to control the rotation speed of the rotating mirror to decrease by the second rotation speed compensation value.

Solution 10. The frame synchronization method according to any one of solutions 1 to 9, where the determining a rotation speed compensation value for phase synchronization adjustment of the rotating mirror based on a phase difference between a phase of the rotating mirror when moving in a same period as the frame synchronization signal and a phase of the frame synchronization signal includes: calculating the phase of the frame synchronization signal based on an obtained frame synchronization signal; calculating the phase of the rotating mirror when moving in the same period as the frame synchronization signal, based on an obtained synchronization point signal of the rotating mirror; calculating the phase difference between the phase of the rotating mirror when moving in the same period as the frame synchronization signal and the phase of the frame synchronization signal; and in response to an absolute value of the phase difference between the phase of the rotating mirror when moving in the same period as the frame synchronization signal and the phase of the frame synchronization signal being greater than a second phase difference threshold, determining an estimated rotation speed compensation value for phase synchronization adjustment of the rotating mirror according to the following equation:

ΔVφ_{estimated}=−Δφ×Kp,

where ΔVφ_{estimated} is the estimated rotation speed compensation value for phase synchronization adjustment of the rotating mirror, Δφ is the phase difference between the phase of the rotating mirror when moving in the same period as the frame synchronization signal and the phase of the frame synchronization signal, and Kp is an adjustment proportional gain.

Solution 11. The frame synchronization method according to solution 10, where the determining a rotation speed compensation value for phase synchronization adjustment of the rotating mirror based on a phase difference between a phase of the rotating mirror when moving in a same period as the frame synchronization signal and a phase of the frame synchronization signal further includes: determining the rotation speed compensation value for phase synchronization adjustment of the rotating mirror based on a relationship between an absolute value of the estimated rotation speed compensation value and a third phase difference threshold, including: when the absolute value of the estimated rotation speed compensation value is greater than the third phase difference threshold, setting the third phase difference threshold as the rotation speed compensation value for phase synchronization adjustment of the rotating mirror; and when the absolute value of the estimated rotation speed compensation value is less than or equal to the third phase difference threshold, setting the estimated rotation speed compensation value as the rotation speed compensation value for phase synchronization adjustment of the rotating mirror.

Solution 12. The frame synchronization method according to any one of solutions 10 to 11, where the determining a rotation speed compensation value for phase synchronization adjustment of the rotating mirror based on a phase difference between a phase of the rotating mirror when moving in a same period as the frame synchronization signal and a phase of the frame synchronization signal further includes: in response to the absolute value of the phase difference between the phase of the rotating mirror when moving in the same period as the frame synchronization signal and the phase of the frame synchronization signal being less than or equal to the second phase difference threshold, setting the rotation speed compensation value for phase synchronization adjustment of the rotating mirror to zero, where the second phase difference threshold is equal to the preset value.

Solution 13. A frame synchronization apparatus for a LiDAR system, including: a first unit configured to determine whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal; a second unit configured to: after the period of the rotating mirror generating the point cloud with the predetermined number of frames is consistent with the period of the frame synchronization signal, determine a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and a third unit configured to: after the phase difference between the phase of the rotating mirror when moving in the same period as the frame synchronization signal and the phase of the frame synchronization signal is less than or equal to the preset value, control the rotation speed of the rotating mirror to be adjusted to a rotation speed used when the period of the rotating mirror generating the point cloud with the predetermined number of frames is consistent with the period of the frame synchronization signal.

Solution 14. A computer device, including: at least one processor; and at least one memory having a computer program stored thereon, where when executed by the at least one processor, the computer program causes the at least one processor to perform the method according to any one of solutions 1 to 12.

Solution 15. An electronic device, including: a LiDAR system; and a frame synchronization apparatus according to solution 13 or a computer device according to solution 14.

Solution 16. A computer-readable storage medium, having a computer program stored thereon, where when executed by a processor, the computer program causes the processor to perform the frame synchronization method according to any one of solutions 1 to 12.

Solution 17. A computer program product, including a computer program, where when executed by a processor, the computer program causes the processor to perform the frame synchronization method according to any one of solutions 1 to 12.

Solution 18. A carrier system, including: at least one LiDAR system as a first sensor; at least one second sensor; a frame synchronization signal generator configured to generate a frame synchronization signal that causes the at least one LiDAR system and the at least one second sensor to be synchronized; and the frame synchronization apparatus according to solution 13 or the computer device according to solution 14.

The foregoing descriptions are merely preferred embodiments of the present disclosure and explanations of the applied technical principles. Those skilled in the art should understand that the scope of the invention involved in the embodiments of the present disclosure is not limited to the technical solutions formed by specific combinations of the foregoing technical features, and shall also cover other technical solutions formed by any combination of the foregoing technical features or equivalent features thereof without departing from the foregoing inventive concept. For example, a technical solution formed by a replacement of the foregoing features with technical features with similar functions in the technical features disclosed in the embodiments of the present disclosure (but not limited thereto) also falls within the scope of the invention.

What is claimed is:

1. A frame synchronization method for a LiDAR system, wherein the LiDAR system comprises a rotating mirror and the frame synchronization method comprises:
determining whether to control a rotation speed of the rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal;
after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and
after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

2. The frame synchronization method according to claim 1, wherein the LiDAR system further comprises a galvanometer mirror, and the frame synchronization method further comprises:
based on an adjusted period of the rotating mirror generating the point cloud with the predetermined number of frames and an adjusted phase of the rotating mirror when moving in the same period as the frame synchronization signal, setting an operation period of the galvanometer mirror to be less than a period of the rotating mirror generating one frame of point cloud, and triggering initial movement of the galvanometer mirror at a phase position where the rotating mirror starts to generate one frame of point cloud.

3. The frame synchronization method according to claim 1, wherein the determining whether to control a rotation speed of the rotating mirror to change by an adjustment value, dynamically based on a period difference between a period of the rotating mirror generating a point cloud with a predetermined number of frames and a period of a frame synchronization signal comprises:
calculating the period of the frame synchronization signal based on an obtained frame synchronization signal;
calculating the period of the rotating mirror generating the point cloud with the predetermined number of frames based on an obtained rotation speed of the rotating mirror;
calculating the period difference between the period of the rotating mirror generating the point cloud with the predetermined number of frames and the period of the frame synchronization signal; and
determining to control the rotation speed of the rotating mirror to change by the adjustment value, in response to an absolute value of the period difference being less than a period difference threshold and not equal to zero.

4. The frame synchronization method according to claim 3, wherein the determining to control the rotation speed of the rotating mirror to change by the adjustment value, in response to an absolute value of the period difference being less than a period difference threshold and not equal to zero comprises:
when the period of the rotating mirror generating the point cloud with the predetermined number of frames is less than the period of the frame synchronization signal, determining to control the rotation speed of the rotating mirror to decrease by the adjustment value, and calculating a cumulative rotation speed compensation value for period synchronization adjustment of the rotating mirror according to the following equation:
ΔVpᵢ=ΔVpᵢ₋₁−ΔV1; or
when the period of the rotating mirror generating the point cloud with the predetermined number of frames is greater than the period of the frame synchronization signal, determining to control the rotation speed of the rotating mirror to increase by the adjustment value, and calculating a cumulative rotation speed compensation value for period synchronization adjustment of the rotating mirror according to the following equation:
ΔVpᵢ=ΔVpᵢ₋₁+ΔV1,
wherein i is a natural number, ΔV1 is an adjustment value, ΔVpᵢ is a cumulative rotation speed compensation value from determination for a first time to control the rotation speed of the rotating mirror to change to determination for an i^{th} time to control the rotation speed of the rotating mirror to change, and ΔVpᵢ₋₁ is a cumulative rotation speed compensation value from the determination for the first time to control the rotation speed of the rotating mirror to change to determination for an (i−1)^{th} time to control the rotation speed of the rotating mirror to change.

5. The frame synchronization method according to claim 3, wherein the determining whether to control a rotation speed of the rotating mirror to change by an adjustment value, dynamically based on a period difference between a period of the rotating mirror generating a point cloud with a predetermined number of frames and a period of a frame synchronization signal further comprises:
determining that the frame synchronization signal is an invalid signal, in response to the absolute value of the period difference being greater than the period difference threshold.

6. The frame synchronization method according to claim 3, wherein the determining whether to control a rotation speed of the rotating mirror to change by an adjustment value, dynamically based on a period difference between a period of the rotating mirror generating a point cloud with a predetermined number of frames and a period of a frame synchronization signal further comprises:
determining to keep the rotation speed of the rotating mirror unchanged, in response to the period difference being equal to zero.

7. The frame synchronization method according to claim 1, wherein the determining a rotation speed compensation value for phase synchronization adjustment of the rotating mirror based on a phase difference between a phase of the rotating mirror when moving in a same period as the frame synchronization signal and a phase of the frame synchronization signal comprises:
adjusting the rotation speed of the rotating mirror by using a predetermined rotation speed compensation value.

8. The frame synchronization method according to claim 1, wherein the determining a rotation speed compensation value for phase synchronization adjustment of the rotating mirror based on a phase difference between a phase of the rotating mirror when moving in a same period as the frame synchronization signal and a phase of the frame synchronization signal comprises:
determining to control the rotation speed of the rotating mirror to increase by a first rotation speed compensation value, in response to an absolute value of the phase difference between the phase of the rotating mirror when moving in the same period as the frame synchronization signal and the phase of the frame synchronization signal being greater than or equal to a first phase difference threshold; or
determining to control the rotation speed of the rotating mirror to increase or decrease by a second rotation speed compensation value, in response to the absolute value of the phase difference between the phase of the rotating mirror when moving in the same period as the frame synchronization signal and the phase of the frame synchronization signal being less than a first phase difference threshold,
wherein the second rotation speed compensation value is less than the first rotation speed compensation value.

9. The frame synchronization method according to claim 8, wherein
when the phase of the rotating mirror when moving in the same period as the frame synchronization signal lags the phase of the frame synchronization signal, determining to control the rotation speed of the rotating mirror to increase by the second rotation speed compensation value; and
when the phase of the rotating mirror when moving in the same period as the frame synchronization signal leads the phase of the frame synchronization signal, determining to control the rotation speed of the rotating mirror to decrease by the second rotation speed compensation value.

10. The frame synchronization method according to claim 1, wherein the determining a rotation speed compensation value for phase synchronization adjustment of the rotating mirror based on a phase difference between a phase of the rotating mirror when moving in a same period as the frame synchronization signal and a phase of the frame synchronization signal comprises:
calculating the phase of the frame synchronization signal based on an obtained frame synchronization signal;
calculating the phase of the rotating mirror when moving in the same period as the frame synchronization signal, based on an obtained synchronization point signal of the rotating mirror;
calculating the phase difference between the phase of the rotating mirror when moving in the same period as the frame synchronization signal and the phase of the frame synchronization signal; and
in response to an absolute value of the phase difference between the phase of the rotating mirror when moving in the same period as the frame synchronization signal and the phase of the frame synchronization signal being greater than a second phase difference threshold, determining an estimated rotation speed compensation value for phase synchronization adjustment of the rotating mirror according to the following equation:
ΔVφ_{estimated}=−Δφ×Kp,
wherein ΔVφ_{estimated} is the estimated rotation speed compensation value for phase synchronization adjustment of the rotating mirror, Δφ is the phase difference between the phase of the rotating mirror when moving in the same period as the frame synchronization signal and the phase of the frame synchronization signal, and Kp is an adjustment proportional gain.

11. The frame synchronization method according to claim 10, wherein the determining a rotation speed compensation value for phase synchronization adjustment of the rotating mirror based on a phase difference between a phase of the rotating mirror when moving in a same period as the frame synchronization signal and a phase of the frame synchronization signal further comprises:
determining the rotation speed compensation value for phase synchronization adjustment of the rotating mirror based on a relationship between an absolute value of the estimated rotation speed compensation value and a third phase difference threshold, comprising:
when the absolute value of the estimated rotation speed compensation value is greater than the third phase difference threshold, setting the third phase difference threshold as the rotation speed compensation value for phase synchronization adjustment of the rotating mirror; and
when the absolute value of the estimated rotation speed compensation value is less than or equal to the third phase difference threshold, setting the estimated rotation speed compensation value as the rotation speed compensation value for phase synchronization adjustment of the rotating mirror.

12. The frame synchronization method according to claim 10, wherein the determining a rotation speed compensation value for phase synchronization adjustment of the rotating mirror based on a phase difference between a phase of the rotating mirror when moving in a same period as the frame synchronization signal and a phase of the frame synchronization signal further comprises:
in response to the absolute value of the phase difference between the phase of the rotating mirror when moving in the same period as the frame synchronization signal and the phase of the frame synchronization signal being less than or equal to the second phase difference threshold, setting the rotation speed compensation value for phase synchronization adjustment of the rotating mirror to zero, wherein the second phase difference threshold is equal to the preset value.

13. A frame synchronization apparatus for a LiDAR system, comprising:
at least one processor; and
at least one memory having a computer program comprising instructions stored thereon,
wherein when executed by the at least one processor, the computer program causes the at least one processor to perform:
determining whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal;
after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and
after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

14. The frame synchronization apparatus for a LiDAR system of claim 13, wherein the computer program further causes the at least one processor to perform:
based on an adjusted period of the rotating mirror generating the point cloud with the predetermined number of frames and an adjusted phase of the rotating mirror when moving in the same period as the frame synchronization signal, setting an operation period of a galvanometer mirror to be less than a period of the rotating mirror generating one frame of point cloud, and triggering initial movement of the galvanometer mirror at a phase position where the rotating mirror starts to generate one frame of point cloud.

15. The frame synchronization apparatus for a LiDAR system of claim 13, wherein the determining whether to control a rotation speed of the rotating mirror to change by an adjustment value, dynamically based on a period difference between a period of the rotating mirror generating a point cloud with a predetermined number of frames and a period of a frame synchronization signal comprises:
calculating the period of the frame synchronization signal based on an obtained frame synchronization signal;
calculating the period of the rotating mirror generating the point cloud with the predetermined number of frames based on an obtained rotation speed of the rotating mirror;
calculating the period difference between the period of the rotating mirror generating the point cloud with the predetermined number of frames and the period of the frame synchronization signal; and
determining to control the rotation speed of the rotating mirror to change by the adjustment value, in response to an absolute value of the period difference being less than a period difference threshold and not equal to zero.

16. An electronic device, comprising:
a LiDAR system; and
a frame synchronization apparatus according to claim 13.

17. A non-transitory computer-readable storage medium, having a computer program comprising instructions stored thereon, wherein when executed by a processor, the computer program causes the processor to perform:
determining whether to control a rotation speed of a rotating mirror to change by an adjustment value, dynamically based on a period difference between a period of the rotating mirror generating a point cloud with a predetermined number of frames and a period of a frame synchronization signal, so that the period of the rotating mirror generating the point cloud with the predetermined number of frames is consistent with the period of the frame synchronization signal;
after the period of the rotating mirror generating the point cloud with the predetermined number of frames is consistent with the period of the frame synchronization signal, determining a rotation speed compensation value for phase synchronization adjustment of the rotating mirror based on a phase difference between a phase of the rotating mirror when moving in a same period as the frame synchronization signal and a phase of the frame synchronization signal, so that the phase difference between the phase of the rotating mirror when moving in the same period as the frame synchronization signal and the phase of the frame synchronization signal is less than or equal to a preset value; and
after the phase difference between the phase of the rotating mirror when moving in the same period as the frame synchronization signal and the phase of the frame synchronization signal is less than or equal to the preset value, controlling the rotation speed of the rotating mirror to be adjusted to a rotation speed used when the period of the rotating mirror generating the point cloud with the predetermined number of frames is consistent with the period of the frame synchronization signal.

18. The computer-readable storage medium of claim 17, wherein based on an adjusted period of the rotating mirror generating the point cloud with the predetermined number of frames and an adjusted phase of the rotating mirror when moving in the same period as the frame synchronization signal, setting an operation period of a galvanometer mirror to be less than a period of the rotating mirror generating one frame of point cloud, and triggering initial movement of the galvanometer mirror at a phase position where the rotating mirror starts to generate one frame of point cloud

19. The computer-readable storage medium of claim 17, wherein the determining whether to control a rotation speed of the rotating mirror to change by an adjustment value, dynamically based on a period difference between a period of the rotating mirror generating a point cloud with a predetermined number of frames and a period of a frame synchronization signal comprises:
calculating the period of the frame synchronization signal based on an obtained frame synchronization signal;
calculating the period of the rotating mirror generating the point cloud with the predetermined number of frames based on an obtained rotation speed of the rotating mirror;
calculating the period difference between the period of the rotating mirror generating the point cloud with the predetermined number of frames and the period of the frame synchronization signal; and
determining to control the rotation speed of the rotating mirror to change by the adjustment value, in response to an absolute value of the period difference being less than a period difference threshold and not equal to zero.

20. A carrier system, comprising:
at least one LiDAR system as a first sensor;
at least one second sensor;
a frame synchronization signal generator configured to generate a frame synchronization signal that causes the at least one LiDAR system and the at least one second sensor to be synchronized; and
a frame synchronization apparatus according to claim 13.
